(19) United States
(12) Patent Application Publication
(10) Pub. No.: US 2013/0290081 A1
(43) Pub. Date: Oct. 31, 2013

(54) SYSTEMS AND METHODS FOR INCENTIVE BASED COMPENSATION

(71) Applicant: Emmanuel Dimitrios Hatzakis, Hoboken, NJ (US)

(72) Inventor: Emmanuel Dimitrios Hatzakis, Hoboken, NJ (US)

(21) Appl. No.: 13/873,984

(22) Filed: Apr. 30, 2013

Related U.S. Application Data
(60) Provisional application No. 61/640,638, filed on Apr. 30, 2012.

(51) Int. Cl. G06Q 30/02

(52) U.S. Cl. CPC G06Q 30/0208
USPC 705/14.11

(57) ABSTRACT

Exemplary embodiments of a method and system for providing an incentive based compensation for an employee in a firm are provided. The employee can have an incentive based compensation that allows for compensation based on cash, firm equity, and service linked securities. The cash can be deliverable immediately, while the firm equity and service-linked securities can be vested and/or deliverable in equal or different portions each year. The service-linked security can be related to various parameters associated with service quality.

### FIELD OF THE DISCLOSURE

The present disclosure relates to exemplary embodiments of methods and systems for providing an incentive based compensation, and more particularly, to exemplary embodiments of methods and systems for providing an incentive based compensation using service-linked securities.

### BACKGROUND INFORMATION

Many different reward based compensation systems exist for rewarding employees, such as commissions based systems. Such systems may utilize incentives and the principal-agent model. Firms can use innovation as a prime competitive weapon. Gross domestic product (GDP) index bonds or warrants are examples of innovative financial securities that have recently begun to be used by countries to hedge risks associated with their economic growth.

There is a need for a method and system in the financial services and other fields for rewarding employees based on an incentive based compensation that takes various parameters into account, as provided for in the exemplary embodiments of the present disclosure.

### SUMMARY OF EXEMPLARY EMBODIMENTS OF THE DISCLOSURE

At least some of the above described problems can be addressed by exemplary embodiments of the methods and systems according to the present disclosure.

The present disclosure describes exemplary embodiments of methods and systems that can provide for an incentive compensation structure for, e.g., front-office employees of a financial firm who handle client transactions in ways that influence clients' perceptions of the quality of service they receive from the firm, and can therefore be in a position to exert a great degree of control on how the firm and its reputation are viewed in the marketplace.

For example, a firm that wants to adhere to the fundamental business principle that its clients' interests always come first, can proceed with confidence in designing and adopting the compensation mechanism described in the exemplary embodiments of the present disclosure for front-office employees that better aligns their interests with those of the firm's clients.

The compensation mechanism for firms according to the exemplary embodiments of the present disclosure can have various characteristics. For example, the firm can use financial engineering to structure service-linked securities with payoffs that are directly linked to service quality received from the firm, as perceived by clients. Service-linked securities can be indexed to metrics that clients consider important for the quality of service they receive from employees of the firm for each type of transaction. The metrics can be transparently observable, easily measurable, directly attributable to each employee involved in a specific transaction, and objectively auditable.

The firm can develop and support an internal market in service-linked securities issued for each employee, whereby other employees of the firm will be trading them for profit. Trade data can uncover “best practice” and “problematic” front-office employees. Service-linked securities can constitute a material part of the incentive compensation for front-office employees. A service-linked security may trade up to its delivery date and awarded at its internal market value, rather than its metrics-based “fundamental” value.

The proposed incentive compensation structure according to the exemplary embodiments of the present disclosure can benefit all stakeholders involved, help enhance the firm's reputation, and silence critics of its client-service practices. Front-office employees can be fairly and objectively rewarded when providing superior service to clients, and perceived as doing so by their colleagues, and/or penalized when not. Clients can benefit because they will be receiving superior quality of service, since front-office employees can be compensated to act in their best interests. The firm and its shareholders can benefit from an increased volume of transactions due to the reputational boost in the marketplace.

The exemplary embodiments of the present disclosure can provide for a method for providing an incentive based compensation structure for an employee of a firm, comprising providing compensation for an employee of a firm in the form of cash, and providing compensation for the employee in the form of service-linked securities. The method can further comprise providing compensation for the employee in the form of firm equity.

The service-linked securities can be linked to service quality received from the firm, and can be indexed to metrics that relate to quality of service provided to one or more clients of the firm. The metrics can be directly related to one or more specific transactions involving the employee and one of the one or more clients. The service-linked securities can be issued for one or more employees of the firm, and can be traded by the employee within the firm. The service-linked securities can be authorized and issued by the firm in dematerialized and uncertificated form. Compensation of the service-linked securities can be accelerated upon the employee's termination. The service-linked securities associated with the employee and a client can be calculated at any time.

The exemplary embodiments of the present disclosure can further provide for a system for providing real-time data for a web-based entity, comprising a storage arrangement configured to store one or more transactions of an employee of a firm with a client of the firm, a storage arrangement configured to store data related to one or more parameters related to quality of service between the employee and the client related to the one or more transactions, and a computing arrangement configured to process a value associated with a service-linked security relating to the one or more parameters.

The service-linked security can be traded by the employee within the firm, and can be authorized and issued by the firm in dematerialized and uncertificated form. The value of the service-linked security can be processed at any time, and compensation for the service-linked security can be accelerated upon the employee's termination.

The exemplary embodiments of the present disclosure can further provide for a computer-accessible medium having instructions thereon for providing an incentive based compensation structure for an employee of a firm, wherein, when a hardware processing arrangement executes the instructions, the computing arrangement is configured to calculate compensation for an employee of a firm in the form of a service-linked security, wherein the service-linked security is related to service quality between the employee and a client of the firm related to one or more transactions between the employee and the client.

The processing arrangement can be further configured to calculate compensation for the employee in the form of firm equity and/or cash. The service-linked security can be traded by the employee within the firm, and the service-linked security can be authorized and issued by the firm in dematerialized and uncertificated form. The processing arrangement can be further configured to calculate compensation for an employee of a firm in the form of a service-linked security at any time.

### DETAILED DESCRIPTION OF EXEMPLARY EMBODIMENTS OF DISCLOSURE

Exemplary embodiments of the methods and systems according to the incentive compensation of the present disclosure are described below.

Initially, in an exemplary embodiment of the present disclosure, an incentive compensation structure can provide for incentive compensation that can be awarded, e.g., at year-end, based on one or more of cash, equity and service-linked securities.

For example, the compensation structure can provide for cash, vesting and deliverable immediately. Cash can mean cash, check or other immediate payment to the employee, such as direct deposit in a bank account or other immediate payment mechanism. The compensation structure can further provide for firm equity, that can vest, e.g., in equal portions over three years, where each portion can be deliverable one year after vesting. Also, service-linked securities can be provided, vesting and deliverable according to the same schedule as the firm equity.

### Exemplary Service-Linked Securities

The service-linked securities according to the exemplary embodiments of the present disclosure can have various characteristics. The service-linked securities can be authorized and issued by the firm in dematerialized and uncertificated form. The ownership of the service-linked securities can be limited only to firm employees, and they cannot be used outside the firm. The value of service-linked securities will be available in cash to the employee to whom they are granted when the firm redeems them upon delivery. Coupons, dividends, or other types of cash flows may not be available to beneficiaries of service-linked securities. Vesting and delivery of service-linked securities can be accelerated upon an employee's termination, in which case their cash value can be determined, e.g., as of close-of-business on the date of the employee's termination. The tax status of incentive compensation by service-linked securities can be determined according to each receiving employee's jurisdiction.

A service-linked security can be issued at the beginning of an annual incentive compensation period at a nominal (or par) value in units denominated in the currency of the receiving employee's jurisdiction. A service-linked security at its nominal value (or valued at par) can carry an implicit assumption that the employee to whom it is awarded provides clients service in line with the average client service quality across all employees of the firm facilitating similar types of transactions as the employee.

The fundamental value of a service-linked security awarded to a firm employee can be calculated at any time based on the employee's performance with respect to a client service index specific to the employee, which can capture all the client transactions that the employee may have contributed in facilitating during a specified time period. The fundamental value can exceed (or fall below) the nominal value, or can be at a premium (or discount) to par, if the employee may have provided better (or worse) than average service to clients.

The firm can develop and support an internal market in service-linked securities issued for each employee, whereby other employees of the firm can trade them for profit, by taking long or short positions. Eligibility of employees for trading service-linked securities can be determined by the firm based on parameters established by the firm. Trading in this market can determine the market value of a service-linked security, while its fundamental value may or may not be available or known to employees who trade the service-linked security.

Significant divergences between market and fundamental values can be important leading behavioral predictors, or can reflect imperfections in service quality metrics currently used, and the need for improvement by refining existing factors or including factors not yet considered. In addition to market value discovery for service-linked securities, trade data can uncover “best practice” and “problematic” front-office employees.

A service-linked security may trade, e.g., up to its delivery date. On or after that date, the firm can redeem an employee's service-linked security, and the employee can receive in cash the service-linked security's fundamental value as of the close-of-business on the delivery date, less any applicable income tax withholding. Open positions, long or short, on the service-linked security by other employees can be settled in cash based on the difference between the market and fundamental value of the service-linked security as of the close-of-business on the delivery date. Any capital gain or loss can be recorded for use in the filing of tax returns.

The service-linked security may be a virtual security in some exemplary embodiments of the present disclosure. For example, the value of the virtual service-linked securities can be discovered through trading in a simulated market, such as an online marketplace internal to the firm. Special algorithms can be written to create a trading simulation that can determine the value of service-linked securities.

Example of Incentive Compensation Structure using Service-linked Securities

In an exemplary embodiment of the present disclosure, an incentive compensation structure using service-linked securities can be provided for a US-based firm employee. For example, a target incentive compensation for a US-based firm employee A for a performance year 2013 can be determined at or near Dec. 31, 2012, and can consist of 90% of a combination of cash and firm equity, in percentages that can be predetermined or set by a firm, and 10% of service-linked securities.

In the example, on Jan. 1, 2013, the service-linked security can be created in units of a nominal value of USD 100.00, and can become available for trading in the firm's systems. Various parameters can be associated with the service-linked security, such as the nominal value of the service-linked security, denoted by N_{A}. N_{A} equals USD 100.00 in this example. Time, which can be denoted by t, can mean any time instant on or after Jan. 1, 2013. Client Service Index of employee A as of time t, denoted by I_{A}(t), can be calculated based on all client transactions that the employee A has contributed in facilitating from the start of business on Jan. 1, 2013 to time t.

For example, if the employee A is an equities trader and has contributed to facilitating the following two client transactions, in an agency capacity for which the agreed-upon metric is Volume-Weighted Average Price (“VWAP”), in the aforementioned time period:
1. Contributed 90% to a buy trade of a stock of a total principal value of USD 10 million at a VWAP in the 76th percentile (or 152% of the median=0.76/0.50) of all similar trades across the firm during the trade's execution.
2. Contributed 100% to a Sell trade of a stock of a total principal value of USD 1 million at a VWAP in the 45th percentile (or 90% of the median=0.45/0.50) of all similar trades across the firm during the trade's execution.

The employee's I_{A}(t) is 1.458, calculated as follows:

$$1.458 = \frac{( 90 \% \times USD 10 million \times 152 \% + 100 \% \times USD 1 million \times 90 \%}{( 90 \% \times USD 10 million + 100 \% \times USD 1 million )}$$

I_{A}(t) can be set to 1.00 at the start of business on Jan. 1, 2013. While the agency equity trades with VWAP was used as the metric for simplicity in the above example, several types of trades with different metrics can be used in the calculation of IA(t) using the above formula.

The fundamental value of the service-linked security as of time t can be denoted by F_{A}(t). F_{A}(t) can equal N_{A} times I_{A}(t). In continuing the example, F_{A}(t) is USD 145.80, at a premium to par, calculated as follows:

F_{A}(t)=N_{A}×I_{A}(t)=USD 100.00×1.458=USD 145.80

F_{A}(t) can be set to the nominal value N_{A}=USD 100.00 at the start of business on Jan. 1, 2013.

The market value of the service-linked security as of time t can be denoted by M_{A}(t). The M_{A}(t) can be set to the service-linked security's nominal or par value of USD 100.00 at the start of business on Jan. 1, 2013. Trading in the service-linked security can bring M_{A}(t) to a premium or a discount to its par value, and can diverge significantly from its fundamental value during the life of the security.

The firm can establish service-linked security transaction size limits that may or may not be related to the number and value of the service-linked security units that have been issued for employee A in the past or are targeted to be issued in the future. Transaction size limits may also be determined by the amount of capital that other employees are willing to commit for trading service-linked securities.

The firm may require transactions in service-linked securities to be pre-cleared by a compliance department, just like transactions in any other securities eligible for trading by firm employees. Pre-clearance data can then be used in addition to actual trades data to uncover “best practice” or “problematic” front-office employees. They can also be used to detect attempts to manipulate service-linked securities trading.

Timelines can be established of awarding, vesting, delivery, and cash settlements of an employee's service-linked securities. In the previous example, as of the close of business on Dec. 31, 2013, which is typically a firm's fiscal year end, the firm may have decided to award employee A an incentive compensation of USD 2,000,000 in the proportions determined at or near the beginning of the fiscal year as follows:
1. USD 1,800,000 (90%) of a combination of cash and firm equity, in percentages that have been determined to be, for example, 20% cash, and 70% firm equity, and
2. USD 200,000 (10%) of par value of service-linked securities, or 2,000 service-linked security units at USD 100.00 each. These 2,000 service-linked security units can vest and be delivered to employee A according to the following schedule:
   a. 667 service-linked security units (the first ⅓rd of 2,000) that can vest on Dec. 31, 2014, and can be delivered on Dec. 31, 2015,
   b. 667 service-linked security units (the second ⅓rd of 2,000) that can vest on Dec. 31, 2015, and can be delivered on Dec. 31, 2016, and
   c. 666 service-linked security units (the remaining ⅓rd of 2,000) that can vest on Dec. 31, 2016 and can be delivered on Dec. 31, 2017.

On Dec. 31, 2013, employee A′s client service index I_{A}(t) is an above average 1.20, and therefore his service-linked security's fundamental value F_{A}(t) is USD 120.00, at a premium to par, which brings the total value of his 2,000 service-linked security's units to USD 240,000. If employee A′s service-linked security's market value M_{A}(t) is USD 105.00 at that time, also at a premium to par, reflecting a reasonable correlation to F_{A}(t).

As of the close of business on Dec. 31, 2014, employee A′s client service index I_{A}(t) has dropped slightly to 1.10, and therefore his service-linked security's fundamental value F_{A}(t) is USD 110.00, at a premium to par, which brings the total value of his 2,000 service-linked security units to USD 220,000. 667 of these service-linked security units are vesting, but are not scheduled to be delivered until Dec. 31, 2015. The employee's service-linked security's market value M_{A}(t) has increased modestly to USD 108.00.

As of the close of business on Dec. 31, 2015, employee A′s client service index I_{A}(t) has increased slightly to 1.12, and therefore his service-linked security's fundamental value F_{A}(t) is USD 112.00, still at a premium to par, which brings the total value of his 2,000 service-linked security units to USD 224,000. Another 667 of his service-linked security units are vesting, but are not scheduled to be delivered until Dec. 31, 2016. His 667 service-linked security units that vested on Dec. 31, 2014 are delivered today. The firm can redeem them and employee A receives USD 74,704 (=667×USD 112.00) in cash, less any applicable income tax withholding. The employee's service-linked security's market value M_{A}(t) has dropped to USD 102.00, and therefore any open service-linked security positions by other employees are settled as a cash credit of USD 10.00 per unit (=USD 112.00−USD 102.00) for short positions, and a cash debit of (USD 10.00) per unit (=USD 102.00−USD 112.00) for long positions.

As of the close of business on Dec. 31, 2016, employee A's client service index I_{A}(t) has dropped to 0.98, and therefore his service-linked security's fundamental value F_{A}(t) is USD 98.00, now at a discount to par. The remaining 666 of his original 2,000 service-linked security units are vesting, but are not scheduled to be delivered until Dec. 31, 2017. The employee's 667 service-linked security units that vested on Dec. 31, 2015 are delivered today. The firm redeems them and employee A receives USD 65,366 (=667×USD 98.00) in cash, less any applicable income tax withholding. The employee's service-linked security's market value M_{A}(t) has dropped to USD 99.00, and therefore any open service-linked security positions by other employees are settled as a cash credit of USD 1.00 per unit (=USD 99.00−USD 98.00) for long positions, and a cash debit of (USD 1.00) per unit (=USD 98.00−USD 99.00) for short positions.

As of the close of business on Dec. 31, 2017, employee A′s client service index I_{A}(t) has dropped to 0.85, and therefore his service-linked security's fundamental value F_{A}(t) is USD 85.00, now at a steeper discount to par. The remaining 666 of his original 2,000 service-linked security that vested on Dec. 31, 2016 are delivered today. The firm redeems them and employee A receives USD 56,610 (=666×USD 85.00) in cash, less any applicable income tax withholding. The employee's service-linked security's market value M_{A}(t) has dropped to USD 92.00, and therefore any open service-linked security positions by other employees are settled as a cash credit of USD 7.00 per unit (=USD 92.00−USD 85.00) for long positions, and a cash debit of (USD 7.00) per unit (=USD 85.00−USD 92.00) for short positions.

In total, the service-linked securities portion of employee A′s incentive compensation grant for fiscal year 2013 amounted to a cash value of USD 196,680 (=USD 74,704+USD 65,366+USD 56,610) less applicable income taxes. This total value of USD 196,680 amounted to USD 3,320 (or 1.66%) less than the targeted (nominal) value of USD 200,000 due to employee's deteriorating client service index during the last two years of the grant's delivery schedule. Further, the information on employee A that became available to the firm through the objective client service index metric reflected in the fundamental values of service-linked securities, and through their trading activity, can be invaluable in managing client service quality and perceptions, as well as reputational risk to the firm.

The exemplary embodiments of the methods and systems described herein can facilitate and/or provide, e.g., an incentive compensation structure for front-office employees of a financial services firm or other firms who handle client transactions in ways that influence clients' perceptions of the quality of service they receive from the firm, and can therefore be in a position to exert a great degree of control on how the firm and its reputation are viewed in the marketplace.

The compensation mechanism for firms according to the exemplary embodiments of the present disclosure can have various characteristics. For example, the firm can use financial engineering to structure service-linked securities with payoffs that are directly linked to service quality received from the firm, as perceived by clients. Service-linked securities can be indexed to metrics that clients consider important for the quality of service they receive from employees of the firm for each type of transaction. The metrics can be transparently observable, easily measurable, directly attributable to each employee involved in a specific transaction, and objectively auditable.

The firm can develop and support an internal market in service-linked securities issued for each employee, whereby other employees of the firm will be trading them for profit. Trade data can uncover “best practice” and “problematic” front-office employees. Service-linked securities can constitute a material part of the incentive compensation for front-office employees. A service-linked security may trade up to its delivery date and awarded at its internal market value, rather than its metrics-based “fundamental” value.

Various other considerations can also be addressed in the exemplary applications described according to the exemplary embodiments of the present disclosure. Different types of companies, such as trading companies, financial companies, help centers, credit card service centers, technical support centers, or any other type of company where service quality can be important, and/or employees are compensated through incentive compensation, can use the incentive based compensation structure described in the exemplary embodiments of the present disclosure for their employees. Different parameters can be used by the firms to provide the compensation, including various percentages for the various parameters.

The exemplary embodiments of the present disclosure can be used in various configurations and in different systems. Various computing arrangements can be provided, having a processor(s) configured or programmed to perform the exemplary steps and/or procedures of the exemplary embodiments of the present disclosure described above. Various data described above can be stored in various storage arrangements (e.g., hard drive, memory device, such as RAM, ROM, memory stick, floppy drive, other tangible computer-accessible medium, etc.). The processor(s) can access the storage arrangement(s) to execute a computer program or a set of instructions (stored on or in the storage arrangement) which can perform the procedures according to the exemplary embodiments of the methods and systems of the present disclosure.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure. The disclosures of all documents and publications cited herein are hereby incorporated herein by reference in their entireties.

What is claimed is:

1. A method for providing an incentive based compensation structure for an employee of a firm, comprising:
providing compensation for an employee of a firm in the form of cash; and
providing compensation for the employee in the form of service-linked securities.

2. The method of claim 1, further comprising:
providing compensation for the employee in the form of firm equity.

3. The method of claim 1, wherein the service-linked securities are linked to service quality received from the firm.

4. The method of claim 3, wherein the service-linked securities are indexed to metrics that relate to quality of service provided to one or more clients of the firm.

5. The method of claim 4, wherein the metrics are directly related to one or more specific transactions involving the employee and one of the one or more clients.

6. The method of claim 1, wherein the service-linked securities are issued for one or more employees of the firm.

7. The method of claim 6, wherein the service-linked securities can be traded by the employee within the firm.

8. The method of claim 1, wherein the service-linked securities are authorized and issued by the firm in dematerialized and uncertificated form.

9. The method of claim 1, wherein compensation of the service-linked securities can be accelerated upon the employee's termination.

10. The method of claim 1, wherein the service-linked securities associated with the employee and a client can be calculated at any time.

11. A system for providing real-time data for a web-based entity, comprising:
a storage arrangement configured to store one or more transactions of an employee of a firm with a client of the firm;
a storage arrangement configured to store data related to one or more parameters related to quality of service between the employee and the client related to the one or more transactions; and
a computing arrangement configured to process a value associated with a service-linked security relating to the one or more parameters.

12. The system of claim 11, wherein the service-linked security can be traded by the employee within the firm.

13. The system of claim 11, wherein the service-linked security is authorized and issued by the firm in dematerialized and uncertificated form.

14. The system of claim 11, wherein the value of the service-linked security can be processed at any time.

15. The system of claim 14, wherein compensation for the service-linked security can be accelerated upon the employee's termination.

16. A computer-accessible medium having instructions thereon for providing an incentive based compensation structure for an employee of a firm, wherein, when a hardware processing arrangement executes the instructions, the computing arrangement is configured to:
calculate compensation for an employee of a firm in the form of a service-linked security;
wherein the service-linked security is related to service quality between the employee and a client of the firm related to one or more transactions between the employee and the client.

17. The computer-accessible medium of claim 16, wherein the processing arrangement is further configured to calculate compensation for the employee in the form of firm equity and/or cash.

18. The computer-accessible medium of claim 16, wherein the service-linked security can be traded by the employee within the firm.

19. The computer-accessible medium of claim 16, wherein the service-linked security is authorized and issued by the firm in dematerialized and uncertificated form.

20. The computer-accessible medium of claim 16, wherein the processing arrangement is further configured to calculate compensation for an employee of a firm in the form of a service-linked security at any time.
